(19) United States
(12) Patent Application Publication
(10) Pub. No.: US 2008/0075885 A1
(43) Pub. Date: Mar. 27, 2008

(54) Method of Controllable Morphology of Self-Assembled Monolayers on Substrates

(76) Inventors: Heng-Yong Nie, Ontario (CA); Mary Jane Walzak, Ontario (CA); Stewart N. McIntyre, Ontario (CA)

Correspondence Address: Ralph A. Dowell of DOWELL & DOWELL P.C., 2111 Eisenhower Ave, Suite 406, Alexandria, VA, 22314, US

(21) Appl. No.: 10/568,619

(22) PCT Filed: Aug. 17, 2004
(86) PCT No.: PCT/CA04/01500

§ 371 Date: May 31, 2007

Related U.S. Application Data
(60) Provisional application No. 60/496,019, filed on Aug. 19, 2003.

(51) Int. Cl. B05D 3/06; B05D 1/02; B05D 3/12; B05D 7/14; B05D 3/00

(52) U.S. Cl. 427/553; 427/240; 427/255.11; 427/299; 427/327

(57) ABSTRACT

Method of controlling the morphology of self-assembled monolayers (SAMS) on substrates having hydrophilic surfaces. The hydrophilic surface is exposed to a fluid having a mixture of molecules which can self-assemble on the hydrophilic surface and hydrophobic molecules for a sufficient length of time so that the molecules which can self-assemble on the hydrophilic surface form a complete self-assembled monolayer. In a particular embodiment octadecylphosphonic acid (OPA) molecules have been self-assembled on oxidized substrates including but not limited to mica, silicon, sapphire, quartz and aluminum by spin-coating a solution containing the octadecylphosphonic acid (OPA) molecules and hydrophobic molecules such as chloroform or trichloroethylene under a controlled relative humidity. Control of the morphology of OPA SAMs is affected by adjusting humidity and the duration of spin-coating. Atomic force microscopy revealed that relative humidity has a profound influence on the morphology of the OPA SAMs formed. When sufficient molecules are applied either consecutively or separately, the final morphology will be a complete monolayer, regardless of the relative humidity.

### FIELD OF INVENTION

The present invention relates to a method of fabricating monolayers with controlled coverage on a substrate, and more particularly the present invention relates to a method of fabricating a complete monolayer on a substrate.

### BACKGROUND OF THE INVENTION

Self-assembly of amphiphilic molecules on a solid surface^{1, 2} provides a simple path to fabricate ordered molecular structures. Self-assembled monolayers (SAMs) are thus considered a platform for uses in many fields, such as biosensors, surface engineering, and surface model systems.³⁻⁶ Mica is frequently used as a demonstration substrate, for it is hydrophilic and atomically flat when freshly cleaved. On such surfaces atomic force microscopy (AFM) has made it possible to reveal the morphology of SAMs on a nanometer resolution. SAMs are usually fabricated in a simple way of immersing^{7-9, 16-18} the mica substrate in the amphiphilic molecules solution in an organic solvent or droppings^{10, 12, 13, 15} the solution onto the substrate followed by a drying process. Various SAMs were found to have different morphology characterised by island-like features^{7-9, 16, 17-19}, a connected layer with pits,⁸ or something intermediate.^{10, 12, 13, 15}

Preparation procedures have an influence on the morphology of SAMs. For example, by changing the immersion time of a mica substrate in octadecyltrichlorosilane (OTS) solution in bicyclohexane, the coverage of SAMs on the substrate has been observed to increase dramatically.⁷ The OTS monolayers formed on a silicon substrate showed a different morphology at the initial stage dependent on whether the experiment was conducted under clean room conditions or in a normal chemical laboratory.

To the knowledge of the present inventors, formation of a complete monolayer of organic molecules on mica or any other substrate without the aid of a polymerization mechanism has not been reported.¹⁹ An apparent exception to this is the reported formations of a complete OTS monolayer either on a mica⁷ or a single crystal silicon¹⁹ substrate; however, such formations have been shown to depend on the particular ability of the OTS molecules to polymerize.⁸

Recently, octadecylphosphonic acid (OPA) has been reported to form SAMs on a mica substrate.^{8, 10-15} Because the system of OPA on mica has a more adaptable chemistry compared, for example, to systems, such as alkanethiol on a Au (111) surface or alkyltrichlorosilane on a Si or mica surface, it serves as a good model system for investigating the fundamentals of SAM formation.⁸ An OPA solution in a hydrophilic solvent ethanol has been used to form partial monolayers on a mica substrate by spread coatings and the resulting morphology of the OPA SAMs is characterized by worm-like features.^{13, 15} The extent of surface coverage of the SAM( coverage morphology) is believed to be a result of the competition between OPA—substrate interfacial tension and that between the OPA and the solvent. By immersing the mica substrate in an OPA solution in another hydrophilic solvent, tetrahydrofuran, the OPA SAMs were observed by AFM to evolve from islands to a connected OPA film but with randomly distributed “holes” or flaws in the film.⁸ Thus, while the overall coverage could be considered to be as high as >90% under some conditions, the presence of these random holes precludes all or most the uses of the SAM (see below). Already, extensive studies of growth mechanisms for OPA SAM's on mica surfaces have been carried out.^{11, 14, 20} However, to date, it has proven impossible to fabricate a complete OPA monolayer on a mica substrate using a hydrophilic solvent.

It would be very advantageous to have a method of fabricating a monolayer that could provide 100 percent coverage of a particular substrate. A large number of applications of this capability can be envisaged including precise patterning semiconductor substrates. A distinct advantage of the OPA SAM over cross-linked OTS polymer is a sharper edge: only van der Waals forces hold individual OPA molecules together. Second, metallic substrates such as aluminum and steel could be protected from aqueous corrosion by coverage with an OPA SAM. The hydrophobic surface would also reject the formation of ice particles on metal surfaces thus reducing the risk of ice build up on aircraft surfaces and/or facilitating its removal with de-icing solvents.

### SUMMARY OF INVENTION

The present invention provides a method for forming monolayers with controlled coverage on substrate materials having hydrophilic surfaces.

In one aspect of the invention there is provided a method of producing a complete monolayer on a substrate having a hydrophilic surface, comprising the steps of:
a) providing a substrate having a hydrophilic surface and pre-treating said hydrophilic surface to remove impurities therefrom; and
b) exposing the hydrophilic surface to a fluid comprising a mixture of molecules which can self-assemble on the hydrophilic surface and hydrophobic molecules for a sufficient length of time so that the molecules which can self-assemble on the hydrophilic surface form a complete self-assembled monolayer.

The present invention also provides a method of producing a monolayer with controlled coverage on a substrate having a hydrophilic surface, comprising the steps of:

a) providing a substrate having a hydrophilic surface and pre-treating said hydrophilic surface to remove impurities from said hydrophilic surface; and

b) exposing the hydrophilic surface to a fluid comprising a mixture of molecules which can self-assemble on the hydrophilic surface and hydrophobic molecules for a sufficient length of time so that the molecules which can self-assemble on the hydrophilic surface form a complete self-assembled monolayer; and

c) adjusting relative humidity (RH), concentration of the molecules which can self-assemble and exposure time of the substrate to the fluid to give a monolayer with a selected percentage coverage of the hydrophilic surface.

In another aspect of the invention there is provided a method of producing a complete monolayer on a substrate having a hydrophilic surface, comprising the steps of:

a) providing a substrate having a hydrophilic surface and pre-treating said hydrophilic surface to remove impurities therefrom; and

b) providing a fluid comprising a mixture of molecules which can self-assemble on the hydrophilic surface and hydrophobic molecules, the molecules which can self-assemble having a moiety which seeks a hydrophilic entity, exposing the hydrophilic surface to the fluid for a sufficient length of time so that the molecules having a moiety which seeks a hydrophilic entity are driven in a presence of the hydrophobic molecules to form a complete self-assembled monolayer.

The present invention also provides a method of patterning a surface of a substrate, comprising the steps of:

a) producing a complete monolayer on a substrate having a hydrophilic surface, comprising the steps of

providing a substrate having a hydrophilic surface and pre-treating said hydrophilic surface to remove impurities therefrom; and

exposing the hydrophilic surface to a fluid having mixture of molecules which can self-assemble on the hydrophilic surface and hydrophobic molecules for a sufficient length of time so that the molecules which can self-assemble on the hydrophilic surface form a complete self-assembled monolayer;

b) masking the surface with the complete self-assembled monolayer formed thereon to produce a masked portion and an unmasked portion of the surface, altering the molecules forming the self-assembled monolayer in the unmasked portion to produce the pre-selected patter.

The present invention to a method of fabricating a monolayer that provides 100 percent coverage of a particular substrate can be utilized for numerous applications. First, complete coverage of a single crystal semiconductor surface by an organic SAM would allow very precise patterning of the semiconductor substrate to be effected through the use of ultra violet radiation to irradiate and decompose OPA organic tails which had been pre-derivatised with an absorbing chromophore. Alternatively, irradiation of the SAM with a focussed electron beam could be used to decompose a selected area of the SAM. A distinct advantage of the OPA SAM over cross-linked OTS polymer is a sharper edge: only van der Waals forces hold individual OPA molecules together. Second, metallic substrates such as aluminum and steel could be protected from aqueous corrosion by coverage with an OPA SAM.

The resultant surface of the SAM is very hydrophobic and is not readily penetrated by water or inorganic corrosion precursors such as chloride ion. In addition to being hydrophobic, the OPA surface is very slippery; this could facilitate metal processing steps such as rolling and forming, such as in container production. The hydrophobic surface would also reject the formation of ice particles on metal surfaces thus reducing the risk of ice build up on aircraft surfaces and/or facilitating its removal with de-icing solvents.

### BRIEF DESCRIPTION OF DRAWINGS

The following is a description, by way of example only, of the method for fabricating a complete monolayer on a substrate, reference being had to the accompanying drawings, in which:

FIG. 1 shows two atomic force microscopy (AFM) images (scan area 1 μm×1 μm) for OPA films on a mica surface obtained by spin-coating one drop (˜2 mm in diameter) of its solution in chloroform under relative humidity of (a) 40% and (b) 75%. The gray scale ranges are 0.5 and 2.0 nm for (a) and (b), respectively.

FIG. 2 shows four AFM images (scan area 1 μm×1 μm) showing morphology change in OPA films on a mica surface by spin-coating its solution in chloroform of (a) one drop (˜2 mm in diameter), (b) another one drop after (a), (c) another eight drops after (b), and (d) a consecutive six drops under a relative humidity of 65%. The gray scale ranges are 2.0, 0.5, 0.1, and 0.2 for (a) to (d), respectively.

FIG. 3 shows time-of-flight secondary ionization mass spectrometry (ToF-SIMS) mass spectra for (a) a freshly cleaved mica substrate, (b) island-like OPA films on mica, and (c) an extensively coated OPA layer showing no morphological contrast. The bare mica surface is identified by the two ion fragments of SiO₂⁻ and SiO₃⁻, while the island-like OPA monolayers is detected by another two ion fragments PO₂⁻ and PO₃⁻ associated with the phosphorus headgroup. The same ion fragments PO₂⁻ and PO₃⁻ are also detected on the OPA sample showing no morphological contrast.

FIG. 4 is a schematically depicted model showing the spin-coating process of forming OPA monolayer on the mica substrate. Because of the hydrophobicity of the solution, headgroups of OPA molecules tend to be rich on the solution surface. When the solution is spread on the mica surface, those headgroups have chances to be in contact with the surface and hence can be transferred to mica surface. If contacted with existing monolayer terminated by the hydrocarbon tails, the OPA molecules will not stay on it because of the strong repelling of the solution from the surface, leaving the monolayer intact. This way, a complete monolayer will be eventually formed.

FIG. 5 shows four AFM images (scan area 1 μm×1 μm) showing morphology change in OPA films on a Si (100) substrate by spin-coating its solution in chloroform of (a) one drop (˜2 mm in diameter), (b) another three drops after (a), (c) another three drops after (b), and (d) another six drops after (c) under a relative humidity of 65%. The gray scale ranges are 2.61, 2.23, 2.31 and 0.37 nm for (a), (b), (c), and (d), respectively.

FIG. 6 shows four AFM images (scan area 1 μm×1 μm) showing morphology change in OPA films on an Al₂O₃ substrate by spin-coating its solution in chloroform of (a) five drops (˜2 mm in diameter), (b) another five drops after (a), (c) another five drops after (b), and (d) another five drops after (c). The gray scale ranges 1.92, 1.12, 0.60 and 0.48 nm for (a), (b), (c), and (d), respectively.

FIG. 7 shows AFM images (scan area: 1 μm×1 μm) obtained on the Al plate (a) before and (b) after the OPA coating. The gray scale ranges are 9 and 13 nm for (a) and (b), respectively.

FIG. 8 shows optical microscopy pictures for water drop on the Al plate substrate (a) before and (b) after the OPA coating. Inserts are for side view of the water drop.

FIG. 9 shows three AFM images (scan area 1 μm×1 μm) showing morphology change in OPA films on a mica substrate by spin-coating its solution in trichloroethylene of (a) one drop (˜2 mm in diameter), (b) five drops after (a), (c) another five drops after (b) under a relative humidity of 57%. The gray scale ranges are 2.86, 1.27 and 0.36 nm for (a), (b) and (c), respectively.

FIG. 10 shows three AFM images (scan area 1 μm×1 μm) showing morphology change in OPA films on a mica substrate by spin-coating its solution in the mixture of chloroform and trichloroethylene of (a) two drops (˜2 mm in diameter), (b) two more drops after (a), (c) another two drops after (b) under a relative humidity of 60%. The gray scale ranges are 2.69, 0.37 and 0.33 nm for (a), (b) and (c), respectively.

FIG. 11 shows three AFM images (scan area 1 μm×1 μm) showing morphology change in OPA films on a Si (100) substrate by spin-coating its solution in trichloroethylene of (a) five drops (˜2 mm in diameter), (b) another five drops after (a), (c) another five drops after (b) under a relative humidity of 65%. The gray scale ranges are 2.98, 2.63 and 0.44 nm for (a), (b) and (c), respectively.

FIG. 12 shows AFM images (scan area 1 μm×1 μm) showing morphology change in OPA films on a mica substrate by dipping the substrate into an OPA solution in mixture of chloroform and trichloroethylene for the (a) first dip, (b) second dip and (c) third dip. The gray scale ranges are 1.77, 1.96 and 2.38 nm for (a), (b) and (c), respectively.

FIG. 13 shows scratch test results on a bare mica substrate and OPA monolayers on a mica substrate. The surface was scratched by a diamond tip under an applied force of 0.5 mN and a speed of 50 μm/s. The scratch testing was conducted on a bare mica substrate and the topographic (a) and friction force (b) images (scan area: 7 μm×7 μm) show clearly the scratches created. On the other hand, there are no scratches created on OPA monolayers as determined by topographic (c) and friction force (d) images for OPA SAMs prepared on a mica substrate. The gray scale for (a) and (c) are 2.6 and 3.6 nm, respectively. The gray scale for (b) and (d) are 3.1-5.6 nA and 2.8-4.9 nA, respectively.

FIG. 14 shows morphological change of OPA monolayers prepared on a Si substrate as a function of temperature. The sample was kept in an oven for 30 min at temperatures of (a) 60, (b) 80 and (c) 90° C. The scan area was 2.3 μm×2.3 μm. The gray scale for (a) to (c) is 1.8, 1.2 and 6.7 nm, respectively.

FIG. 15 shows images (scan area: 10 μm×10 μm) on an area with (a) and without (b) being scratched prior to the OPA monolayer deposition on a Si substrate. The gray scale is 2.6 nm for both (a) and (b).

FIG. 16 shows images (scan area: 1 μm×1 μm) of dodecylphosphonic acid monolayers spin coated on a mica substrate at a RH of (a) 90% and (b) 35%. The gray scale is 0.8 and 0.3 nm for (a) and (b), respectively.

FIG. 17 shows images (scan area: 1 μm×1 μm) of sputtered Al film on a Si substrate before (a) and after (b) coating OPA monolayers on the surface. The gray scale is 1.6 and 4.7 nm for (a) and (b), respectively.

### DETAILED DESCRIPTION OF THE INVENTION

### Definitions:

As used herein, the term “self-assembled monolayers (SAMs)” means two-dimensional ordered and oriented molecular assemblies formed by spontaneous adsorption of amphiphilic molecules on a substrate. Usually, there are two interactions that are critical for the formation of SAMS; 1) strong interaction between the hydrophilic moiety of the molecule and the substrate and 2) a balanced force between the hydrophobic molecular chains.

As used herein, the term “substrate with a hydrophilic surface” means any substrate having a high surface energy so that water spreads out on the surface.

As used herein, the phrase “full or complete monolayer” means a monolayer without detectable openings or patches from images obtained by AFM whose lateral resolution is one nanometer or less.

As used herein, the phrase “functionalizing the molecules forming the self-assembled monolayer with pre-selected moieties” means addition of selected functional groups on the organic, hydrophobic end of the amphiphilic molecules, using chemical solutions, gas phase treatment using reactive chemicals or plasma or UV-ozone treatment.

The present invention discloses a method of fabricating monolayers with controlled coverage on a substrate, and more particularly the present invention discloses a method of fabricating a complete monolayer on a substrate. Although most SAMs reported in the literature were fabricated by an immersion method, spin-coating has proved effective in fabricating thin organic films on solid surfaces.^{21,22} For fabricating SAMs on a mica substrate, a hydrophilic solvent is often chosen for the apparent rational that the solution wets the mica surface. Because a hydrophobic solution repels strongly from the mica surface, it may seem undesirable to use such a solution for SAMs fabrication. Contrary to the latter, however, the inventors have discovered that the use of a hydrophobic solution followed by spin-coating leads to a controllable morphology of OPA SAMs and ultimately a complete OPA monolayer formed on a mica substrate.

Thus, the present method in its broadest involves producing a complete monolayer on a substrate having a hydrophilic surface by pre-treating the hydrophilic surface to remove impurities therefrom followed by exposure of the hydrophilic surface to a fluid comprising a mixture of molecules which can self-assemble on the hydrophilic surface and hydrophobic molecules for a sufficient length of time so that the molecules which can self-assemble on the hydrophilic surface form a complete self-assembled monolayer. The fluid is preferably a liquid dispersion containing the molecules which can self-assemble and the hydrophobic molecules in which the substrate is immersed. A preferred method of spreading the fluid across the surface of the substrate includes spin coating the hydrophilic surface with the liquid dispersion in contact therewith.

The invention will now be illustrated with the following non-limiting examples which are intended to illustrate, but and not limit the scope of the present invention in any way.

### EXAMPLE 1

In this example, the method involves combining a hydrophobic solvent and spin-coating to fabricate octadecylphosphonic acid (OPA) self-assembled monolayers (SAMs) on a Muscovite mica substrate and to control their morphology.

As mentioned above, although most SAMs reported in the literature are fabricated by an immersion method, spin-coating has proved effective in fabricating thin organic films on solid surfaces.^{21, 22} This method allows one to investigate how humidity influences the formation of the OPA monolayer through control of the relative humidity (RH) under which the spin-coating is conducted.

### Materials and Methods

A 1 mM OPA [CH₃(CH₂)₁₇PO(OH)₂; Alfa Aesar, Ward Hill, Mass.] solution in chloroform (CHCl₃) was used for preparing OPA samples on freshly cleaved Muscovite mica substrates [KAI(AlSi₃O₁₀)(OH)₂]. The solution was subjected to an ultrasonic oscillation for 30 min before use to ensure OPA was completely dissolved in chloroform. In order to see the initial formation of the morphology, a drop of OPA solution (˜2 mm in diameter) was applied to the mica substrate rotated at a speed of 5,000 rpm. The spin-coating was conducted in a closed environment where the controlled RH was measured with a hygrometer (Omega RH-200° C.). Multidrops of OPA solution were also applied to mica substrates to investigate the morphological variations of the OPA film upon multiple coatings in addition to the initial coating.

Dynamic force mode AFM (TopoMetrix's Explorer) was employed to evaluate the morphology of the OPA films prepared on the mica substrate. A rectangular shaped silicon cantilever with a nominal spring constant of 40 N/m and resonant frequency of ˜300 kHz was used. The cantilever was 125 μm long, 35 μm wide and 4 μm thick. The tip integrated on the cantilever had a nominal apex radius of 10 nm. The oscillation amplitude of the cantilever in free space was on the order of 40 nm. AFM images were obtained by scanning the tip across the sample surface at a certain proximity where a 50% damped oscillation was maintained. Scan speed was 5 μm/s and the image consists of 500×500 pixels.

A ToF-SIMS (Cameca ToF-SIMS IV) was used to detect the presence of OPA on the mica substrate. A primary Ga⁺ ion beam used to bombard the sample surface was 10 keV. The secondary negative ion fragments were collected from an area of 500 μm square. Two characteristic ion fragments used for detecting the presence of OPA molecules were PO₂⁻ and PO₃⁻, while the mica substrate was identified by the presence of SiO₂ and SiO₃⁻ ion fragments.

### Results

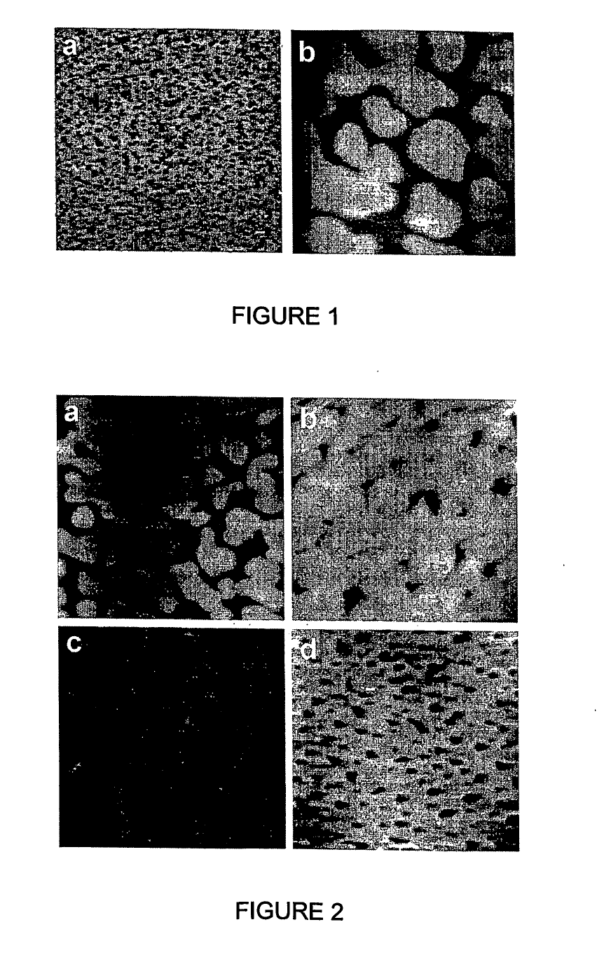

Shown in FIG. 1 are AFM images that were obtained for two samples prepared by applying one drop of OPA solution in chloroform on freshly cleaved mica substrate rotated at 5000 rpm under a RH of (a) 40% and (b) 75%. At the higher RH, large islands are formed and their height is ˜1.6 nm. Because a straight OPA molecule would measure 2.5 nm, a measured height of 1.6 nm suggests that the OPA molecules tilt an angle of ˜50° to the normal of the mica substrate. This height is in agreement with those observed on OPA monolayers made from its solution in hydrophilic solvents such as ethanol.^{10, 12, 15}

The inventors have observed that OPA islands become smaller and often less distant when the RH was decreased. When the RH reached a certain value, the OPA islands coalesced and small pits appeared in the film, as shown in FIG. 1 (a). The morphology of OPA SAMs thus appears to be sensitive to the RH under which the spin-coating is conducted. Mica is believed chemically inactive to some amphiphilic molecules like OTS; thus cleaved mica substrates were moisturised before use.⁸ The SAMs formation for OTS is related to the particular ability of the OTS molecules to polymerize⁸ and the water film on the surface is believed to be an important factor to form a complete monolayer.²³ However, this seems not the case for our spin-coating OPA solution in chloroform on a mica substrate because, from our experimental results, lower RH actually leads to an easier formation (more coverage) of OPA SAMs. Because the solution used to fabricate the two different samples shown in FIGS. 1 (a) and 1 (b) was identical, the OPA islands formed under high RH is suggested to be due to the rearrangement of OPA molecules on the mica substrate, excluding the possibility that they are due to a transfer of island-like monolayers existing in the solution.

The images shown in FIG. 1 can be considered the initial formation of the OPA SAMs because the application of one drop of OPA solution is the minimum coat that we could control. Regardless of the initial OPA film morphology formed on a mica substrate, we discovered that further application of OPA solution, either separately or consecutively, led to the formation of a complete monolayer. To demonstrate our ability of controlling the morphology of OPA SAMs through spin-coating OPA solution in chloroform on mica substrates, we exhibit a series of OPA samples fabricated under 65% RH. FIG. 2 (a) shows an image obtained on a sample made by applying one drop of OPA solution in chloroform to a 5000 rpm rotated, freshly cleaved, mica substrate. The initial OPA film is characterised by island-like features. After AFM imaging, the same sample was subjected to spin-coating once again for another drop of OPA solution. This action resulted in a change of the morphology shown in FIG. 2 (a) to the one shown in FIG. 2 (b). It is clear from comparison of the two images that the OPA islands coalesced in a great degree as the result of the second spin-coating. Therefore, the morphology change between FIGS. 2 (a) and 2 (b) suggests that the OPA islands can be eventually connected to a complete layer if sufficient solution is supplied.

Shown in FIG. 2 (c) is an image obtained on the sample after it was subjected for the third time to spin-coating for another 8 drops of the OPA solution. At this point, we have a surface showing an absence of morphological contrast, suggesting the openings seen in FIG. 2 (b) have been completely filled. The surface for the OPA film shown in FIG. 2 (c) is indeed very smooth and the root mean square roughness is only ˜0.02 nm. From the morphology change shown in FIGS. 2 (a)-(c), which results from increasing the amount of OPA solution applied to the surface, it is clear that a complete OPA monolayer is responsible for the absence of morphological contrast in the image in FIG. 2 (c).

We described above how morphology of OPA films changes when OPA solution in chloroform was separately applied to the surface. We also confirmed that applying consecutively multidrops of OPA solution on a mica substrate results in the formation of a complete layer similar to that shown in FIG. 2 (c). It is interesting to note that under intermediate conditions, for example when applying five drops of the OPA solution on a mica substrate, a connected OPA layer with pits was obtained [see FIG. 2 (d)]. The coverage of OPA SAMs on a mica substrate is determined by the amount of the solution (or more precisely, the solute) applied to the spun substrate. One drop of the solution applied to the surface resulted in a film characterized by islands at a RH of ˜65% [see FIG. 2 (a)]. An increase in amount of the solution resulted in the connection of the discrete islands [FIG. 2 (b)] or a connected layer with pits in the film [FIG. 2 (d)], depending how much solution is applied to the surface. Eventually, the openings in the OPA film were filled so that a complete monolayer emerged [FIG. 2 (c)]. As shown in FIGS. 2 (a)-(b), this process can be “recorded” by imaging the morphology and then subjecting the sample to further coatings. Regardless of whether the film was fabricated by a consecutive coating or several separate coatings, the final coverage of OPA SAMs appears to be the same when adequate solution is applied: a full coverage. By adjusting RH, spin speed and concentration of the OPA solution, it was possible to readily control OPA SAMs with coverage from 15 to 100%.

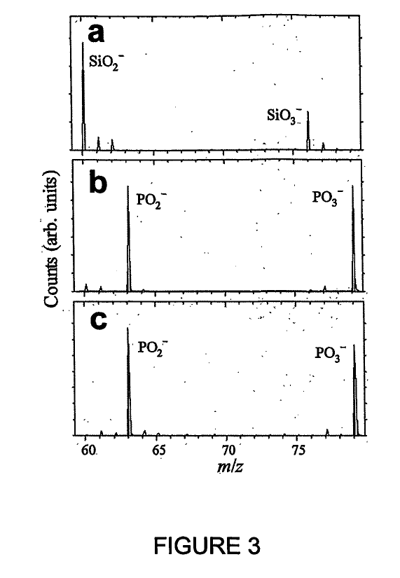

In order to verify that a complete OPA monolayer is indeed responsible for the absence of morphological contrast seen in FIG. 2 (c), we used ToF-SIMS to detect the presence of OPA molecules on the mica substrate. Shown in FIG. 3 are mass spectra obtained on (a) a bare mica substrate, (b) an OPA sample that has island-like features [e.g., FIGS. 2 (a)], and (c) a sample with extensive coating of OPA that has no morphological contrast [FIG. 2 (c)]. On the bare mica surface, SiO₂⁻ (mass/charge ratio m/z=60) and SiO₃⁻ (m/z=76) ion fragments were detected. Those ion groups are most likely originated from the mica substrate itself, which is characterized by a sheet structure²⁴ of the tetrahedral silicate groups (SiO₄). For the OPA monolayer characterized by island-like features [FIG. 2 (a)], PO₂⁻ (m/z=63) and PO₃⁻ (m/z=79) ion fragments were detected, showing that the two ion fragments can be used to identify OPA monolayers on a mica substrate. These two ion fragments were also detected on the sample that had an extensive OPA spin-coating and showed no morphological contrast [FIG. 2 (c)]. The TOF-SIMS measurement thus confirmed the AFM observation of that the absence of morphological contrast on the sample surface [FIG. 2 (c)] is due to the formation of a complete monolayer.

Because chloroform is repelled very strongly from a mica substrate, at a first glance, it may be thought, based on the currently accepted understanding of these systems, that OPA solution in chloroform will not form good monolayers on mica substrate. However, as the results disclosed herein clearly show, OPA solution in chloroform, coupled with spin-coating, can easily make a complete monolayer on a mica surface. This experimental fact provides a clue leading the inventors to conclude that the headgroup of OPA in a hydrophobic solution may well be enriched at the solution-air interface. It is those headgroups seeking a hydrophilic surface to escape from the solution that makes the well-controlled OPA monolayer on a mica surface.

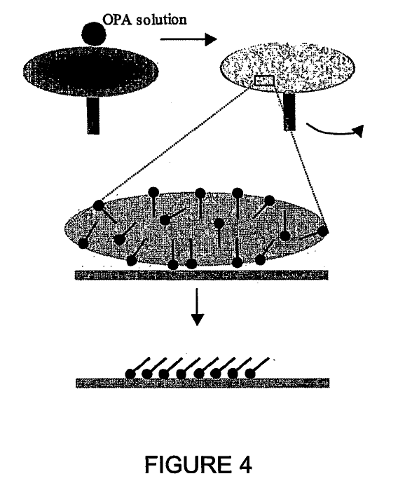

This idea is depicted in FIG. 4. FIG. 4 is a schematically depicted model showing the spin-coating process of forming OPA monolayer on the mica substrate. Because of the hydrophobicity of the chloroform, headgroups of OPA molecules tend to be rich on the solution surface. When the solution is spread on the mica surface, those headgroups have chances to be in contact with the surface and hence can be transferred to mica surface. If contacted with existing monolayer terminated by the hydrocarbon tails, the OPA molecules will not stay on it because of the strong repelling of the solution from the surface, leaving the monolayer intact. Thus, when the solution is being repelled from the mica surface, headgroups in the solution tend to escape from the solution and the only route for them to do so is that they attach to the mica surface. This is the mechanism for the formation of OPA monolayers from its solution in chloroform when being spread on a mica surface. Because there is no multilayer formation on the existing monolayers after the OPA solution is applied to a surface where OPA SAMs has been formed previously [FIG. 2], one can imagine that OPA molecules coming afterwards are not in favour of interactions with the existing monolayer to form something like a bilayer. This is possible only if the headgroup is enriched at the air-solution interface. This is what differs the effect of a hydrophobic solution from a hydrophilic one. Another condition for this to happen is the fact of the extreme strong repelling of the hydrophobic solution from the surface, so that molecules inside the solution do not have a good chance to interact with the existing monolayer. A hydrophobic solution spreading on the mica surface assisted by spinning is necessary for the formation of a complete monolayer. By understanding those factors influencing the formation of OPA SAMs on a mica surface, the morphology of the monolayer becomes controllable.

No complete OPA monolayer has previously been fabricated by an immersion or spreading method using a hydrophilic solvent.^{8, 10, 12, 13, 15} The inventors have tried spin-coating of an ethanolic OPA solution, a commonly used hydrophilic solvent, but did not achieve OPA monolayers on cleaved mica surfaces. Therefore, it is worth emphasizing that the use of a hydrophobic solvent chloroform and spin-coating are keys to fabricating a complete monolayer in this particular example of substrate and SAMs.

At ambient pressures a water film^{25, 26} is condensed on the mica substrate: RH may influence the distribution of such a film on the surface.²⁷⁻³⁰ It has been suggested that water content is strongly involved in the formation of SAMs on mica in a solution.^{7, 17, 18, 23} It appears that RH has a profound influence on the morphology of OPA SAMs: the higher the RH, the lower the coverage of OPA monolayers formed on the mica substrate. A mica surface with more water adsorption is believed to result in SAMs with higher coverage for immersion methods.^{7, 17, 18, 23} The relationship between the morphology of our OPA SAMs and water film coverage shown in FIG. 1 clearly suggests a different formation mechanism. One possible explanation for this is the different method used herein to fabricate the SAMs: the adoption of hydrophobic solvent and spin-coating. The inventors have also confirmed that, regardless of the different water film resulting from different RH, the morphology of OPA SAMs only differs at the initial stage and eventually becomes the same complete monolayer if sufficient OPA solution is supplied.

Without being bound by any theory, the inventors explain the humidity-induced morphology changes shown in FIG. 1 by considering differences in water vapour pressure. In order to demonstrate that water vapour pressure may be related to the humidity-controlled initial morphology of OPA, we conducted an experiment by cleaving a mica substrate under >60% RH and then maintaining it there for 5 min followed by a spin-coating under 35% RH. The resulting morphology was similar to the one that would have been obtained by cleaving and spin-coating a mica substrate at 35% RH. Thus, it appears that the vapour pressure of water during spin-coating is the determinant of surface structure rather than any water adsorbed onto the surface during cleavage. A higher water vapour pressure may tend to confine OPA molecules within a certain area and could lead to separated domains like the observed island-like features seen in FIG. 1 (b). When RH decreases, the domains tend to be smaller and will eventually be connected to each other as shown in FIG. 1 (a).

As shown above, we have explained the initial formation of OPA SAMs on mica surfaces. However, what is more important is that, regardless of the RH under which the experiment was conducted, adding sufficient OPA solution in chloroform on a mica substrate eventually resulted in a complete monolayer. This experimental fact indicates that OPA molecular headgroups will eventually find a position on the mica substrate under any RH level. The rate for OPA molecules to be attached to the mica surface appears to be dependent primarily on the RH. This process of the formation of SAMs can thus be qualitatively understood as being controlled by an activation energy, which decreases with the decrease water vapour pressure. Of course, solution concentration also influences SAMs coverage. It is worth noting that if one wants to control more easily the coverage of OPA SAMs on mica, a more diluted solution and a higher RH may be necessary.

Based on the above, this example shows the establishment of a novel method of delivering a complete amphiphilic molecular monolayer on a mica substrate by spin-coating an OPA solution in chloroform. The initial morphology of OPA SAMs is highly dependent on the relative humidity, under which the spin-coating is conducted. We found that regardless of the initial morphology a complete OPA monolayer is easily achievable when sufficient solution is supplied in the spin-coating process. It is proposed that the headgroups of OPA molecules in the hydrophobic solvent chloroform seeking a hydrophilic entity outside the solution is the driving force for the formation of a complete monolayer on the mica substrate.

### EXAMPLE 2

In EXAMPLE 1, the inventors have described a method of controlling OPA monolayers on a Muscovite mica substrate. This method easily delivers a complete monolayer on the mica surface. We confirmed that a complete monolayer is achievable on Biotite, another type of mica substrate. This is quite predictable because the surface structure for both Muscovite and Biotite mica is the same: their surface is characterized by arrays constructed by the basal oxygen atoms from the tetrahedral silicate (SiO₄). To show the potential of the OPA technology, we tried other flat substrates. Here we provide another example of delivering OPA monolayers on a semiconductor Si (100) substrate.

A 0.25 mM OPA solution in chloroform was used for preparing OPA samples on a Si(100) substrate. The substrates were washed using methanol followed by being exposed to ozone with the presence of UV irradiation for surface cleaning for 45-60 min. This UV/ozone treatment appears highly effective in cleaning surface contaminations, thus increasing the surface energy of the substrate. Then the solution was spin-coated on the substrate rotated at 5000 rpm. The spin-coating was done under a RH of 65%. To “record” the growth of the OPA monolayers formed on the Si substrate, the sample was consecutively subjected to OPA spin-coating, during which AFM images were obtained. AFM imaging conditions is the same as described in EXAMPLE 1.

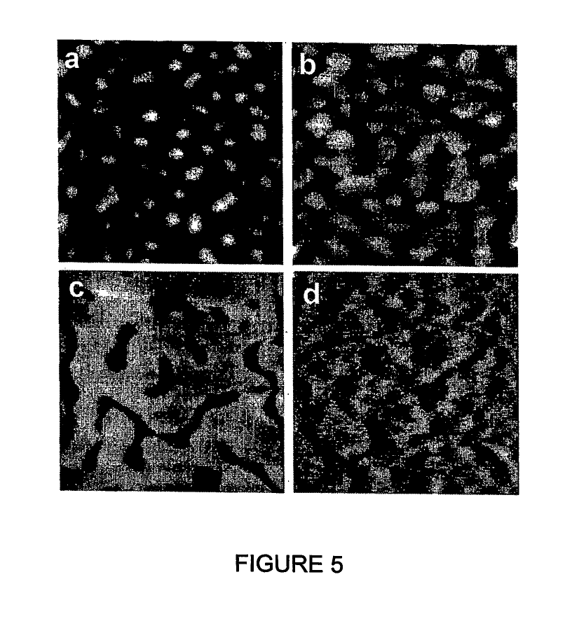

Shown in FIG. 5 are AFM images for the formation of OPA monolayers on a Si (100) substrate. When one drop of the OPA solution was applied to the substrate, separated dot-like structures were observed [FIG. 5 (a)]. The height of the features suggests that they are OPA monolayers. Then the same sample was subjected to spin-coating for three drops of the solution, which resulted in that the dot-like features were connected [FIG. 5 (b)]. After another three drops of the solution were applied to the surface, the monolayers were connected further [FIG. 5 (c)]. This process of filling-up of OPA monolayers continued when more solution was applied to the surface. After six more drops of the solution were applied to the surface, a complete OPA monolayer was achieved on the Si substrate [FIG. 5 (d)].

To our knowledge only silanes can form a complete monolayer on a Si substrate,¹⁹ which is due to the specific ability of lateral polymerization⁸ of the siloxane molecules on the Si substrate. Our method shows that a complete OPA monolayer is achieved on a Si substrate, while the conventional method does not even produce OPA monolayers on a Si substrate.¹⁵ Considering that OPA is a general amphiphilic molecule, our method is promising in delivering a complete monolayer of a molecule that one can choose.

Recently, electron-beam lithography with biphenyl (e.g., 4-hydroxybiphenyl) SAMs on H-terminated Si surfaces was reported.³¹ The method for preparing the aromatic SAMs was based on a previous work³² that describes formation of aliphatic alcohols on H-terminated Si surface using immersion method. No morphology (i.e., coverage) investigation was reported for the aromatic SAMs, and oxide free surface appeared to be key point for the formation of SAMs. By contrast, our SAMs were found to be strongly bonded to oxidized Si surface and are able to provide a complete coverage for the oxide substrate. Therefore, as shown in following examples, our method is applicable to oxidized surfaces.

### EXAMPLE 3

Further to EXAMPLE 2, we show here that a complete OPA monolayer can also be delivered on an Al₂O₃ (alumina) substrate. The sample preparation procedure was the same to that described in EXAMPLE 2.

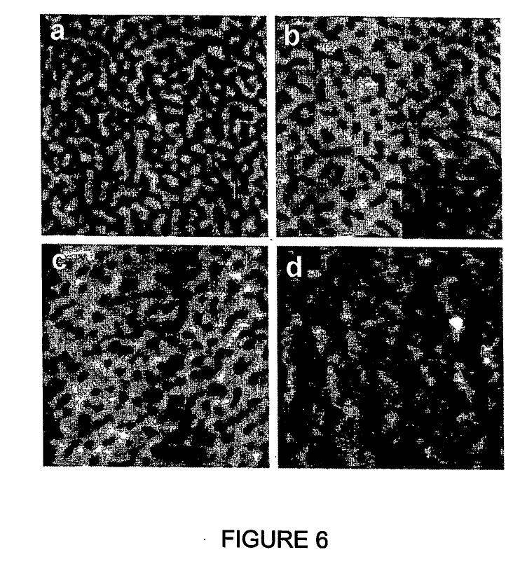

Shown in FIG. 6 are AFM images for the formation of OPA monolayers on an Al₂O₃ substrate. After five drops of the OPA solution were applied to the substrate, observed were features with a height that suggests that they are OPA monolayers [FIG. 6 (a)]. Then the same sample was subjected to OPA spin-coating for another five drops of the solution. After this second spin-coating, it is clear that the monolayers were filled up largely [FIG. 6 (b)]. After the third five drops of the solution were applied to the surface, the filling-up of the monolayers continued [FIG. 6 (c)]. Note that the height scale is much smaller for FIG. 6 (c) (0.60 nm) than for FIG. 6 (b) (1.12 nm). The insert in FIG. 6 (b) shows the change in appearance when the gray scale is adjusted to 0.60 nm, the same to that for FIG. 6 (c). Therefore, the OPA monolayers packed more closely in FIG. 6 (c) than in FIG. 6 (b). After the fourth five drops of the solution were applied to the surface, a complete OPA monolayer was achieved [FIG. 6(d)].

The above demonstrated how we can “record” the growth of OPA monolayer. In practice, of course, one only needs to finish coating at once. By increasing the concentration of OPA solution, fewer drops would result in a complete monolayer. In any case, the coating process only takes a few seconds. Our method is thus extremely quick in delivering a complete OPA monolayer on an Al₂O₃ surface, as well as on Si and mica surfaces.

It is noted that there is a literature³³ account reporting the formation of OPA monolayers on Al₂O₃ substrates. The substrates were immersed in OPA solution in THF (tetrahydrofuran, which is a hydrophilic solvent). They reported that no complete OPA monolayer was ever achieved even after the substrates were immersed in the hydrophilic solution for 15.5 hours (the longest immersion they performed).³³ In contrast to this conventional method, the present invention provides a method for obtaining a complete OPA monolayer on an Al₂O₃ substrate in a mater of seconds. This comparison serves as a good example with respect to the differences in the delivering mechanism between the method disclosed herein and the conventional methods.

### EXAMPLE 4

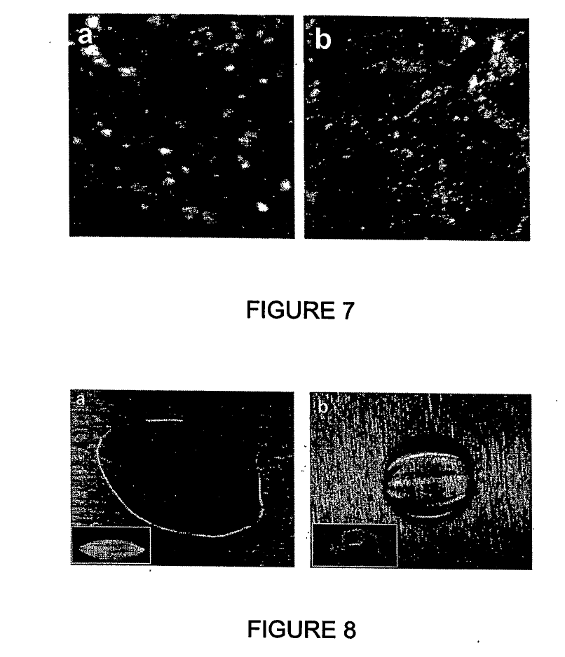

The substrates we have used in EXAMPLES 1-3 to demonstrate the formation of OPA monolayers have a very flat surface. It would be very advantageous if the method of 100% monolayer OPA formation disclosed herein can also be used to make monolayers on a rough substrate. We tried depositing OPA on an aluminum plate for potential use of the technology to a more wide range of surfaces. The Al plate was cleaned by methanol wash followed by an UV/ozone treatment for 45 min. Shown in FIG. 7 are AFM images for the Al plate before [FIG. 7 (a)] and after [FIG. 7 (b)] the OPA coating of 20 drops of 0.25 mM OPA solution in chloroform. As suggested in EXAMPLE 3, this coating condition would form a complete monolayer on the Al₂O₃ substrate. As shown in FIG. 7, because of the roughness of the Al plate, it is difficult for the AFM to detect whether OPA monolayers present on the surface.

If OPA molecules do produce monolayers on such a rough surface, then the surface chemistry has to be changed. Contact angle measurement is a very easy way to detect this change. FIG. 8 shows optical microscopy pictures showing the top view of a water drop on the Al plate cleaned by UV/ozone treatment (the insert is a side view of the water drop) before [FIG. 8 (a)] and after [FIG. 8 (b)] the OPA coating. It is clear that the probing water drop wets the Al plate: the static contact angle was only 15° [FIG. 8 (a)]. This indicates that the Al plate was made hydrophilic by the UV/ozone treatment. After the Al plate was OPA-coated, the water drop beads up on the surface as shown in FIG. 8 (b). The static contact angle measured 82° for the OPA-coated Al plate, indicating that the Al plate surface had become hydrophobic after the OPA coating. It is thus believed that OPA monolayers are formed on the rough Al plate substrate.

Additional proof of OPA attachment to the aluminum plate surface comes from TOF-SIMS measurements. A prominent signal for the ion PO₂⁻ is used as indication of attachment of the OPA to this substrate, just as has been found for the other examples.

### EXAMPLE 5

Using the spin-coating method, complete OPA monolayers on mica and silicon wafer substrates are synthesized in this example using the hydrophobic solvent, trichloroethylene (TCE). The formation of OPA monolayers on these substrates was thoroughly examined by changing experimental parameters such as solution concentration, spin-speed, and relative humidity. In general, higher humidity facilitates the formation of complete monolayer both for Si and mica substrates. The morphology of OPA monolayers is controllable by those parameters. The combination of the two solvents (i.e., chloroform and TCE) also produces monolayers. TCE is attractive as a delivery solvent because its low toxicity. It is commonly used as a dry cleaning solvent. As well, AFM images of monolayers produced using TCE show fewer local flaws than do these produced using chloroform.

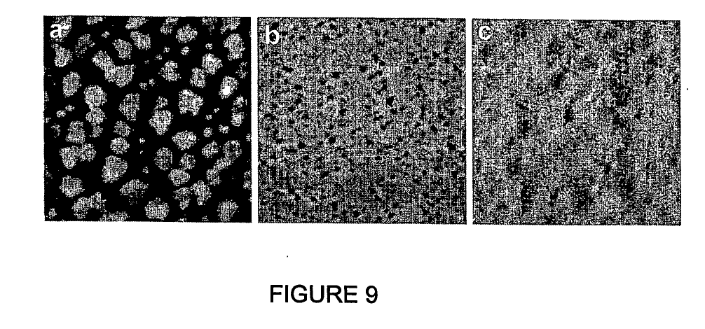

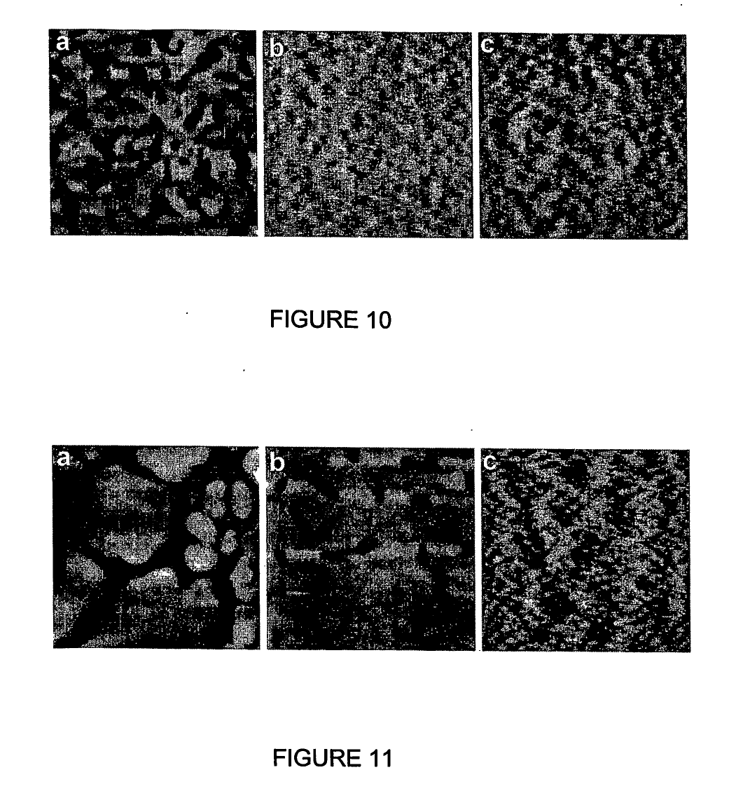

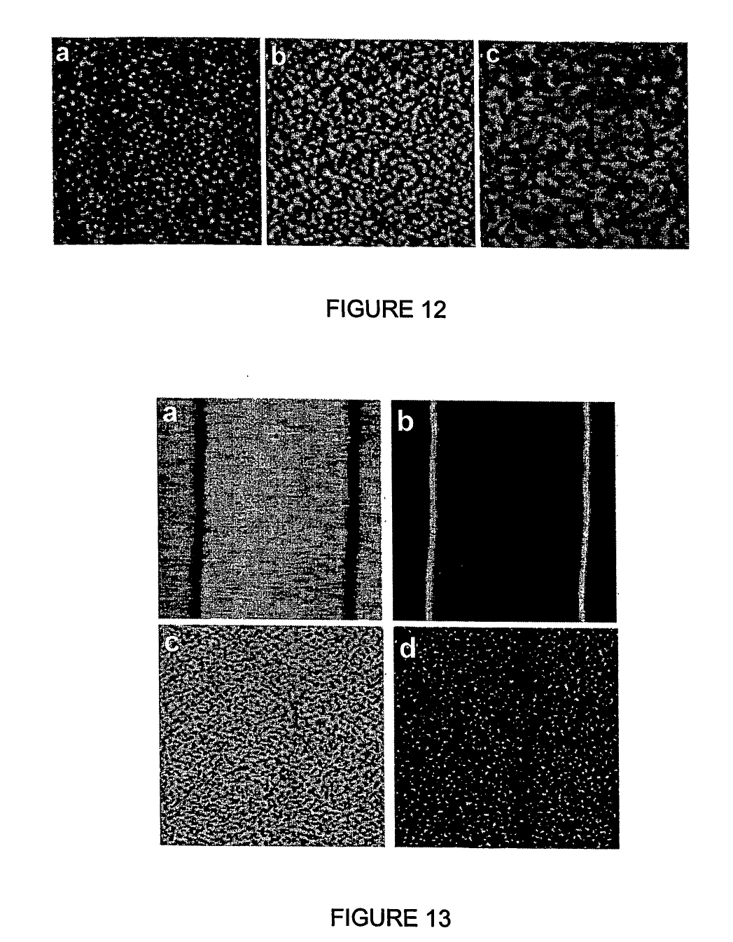

An OPA solution in TCE was able to deliver quite easily a complete monolayer on mica substrates both at lower and higher relative humidity. The results for OPA SAMs formed under a high relative humidity are shown in FIG. 9. The concentration of the OPA solution in trichloroethylene was 10 mM. Spin-coating by applying one drop of the solution resulted in islands of OPA SAMs [FIG. 9 (a)]. Applying more solutions on the surface resulted in coalescence of the islands [FIG. 9 (b)] and eventually a complete monolayer [FIG. 9 (c)]. A mixture of chloroform and trichloroethylene is also good for delivering a complete OPA monolayer on a mica substrate. Shown in FIG. 10 are AFM images for OPA SAMs fabricated under high relative humidity using 4 mM OPA solution in such a mixture. When increasing the amount of the solution applied to the surface, growth of the SAMs is seen from connected islands [FIG. 10 (a)] to a layer only with small pits [FIG. 10 (b)], and finally to a complete monolayer [FIG. 10 (c)].

After discovering that TCE can deliver a complete monolayer on mica, the inventors tried a more practically useful silicon wafer, Si (100). FIG. 11 shows the growth of a complete monolayer on the Si substrate. The Si substrates were washed by methanol followed by 30-45 min UV/ozone treatment. Then a succession of drops of 2 mM OPA solution in TCE was placed on the rotating substrate. As the total quantity of added OPA was gradually increased in this way, the disconnected OPA monolayers [FIG. 11 (a)] joined to become larger islands [FIG. 11 (b)], then a complete monolayer [FIG. 11 (c)]. Higher relative humidity is necessary to achieve a complete monolayer on the Si substrate. The OPA SAMs shown in FIG. 11 were formed under a high relative humidity of 65%.

### EXAMPLE 6

Using the TCE solvent, we have explored other non-spin-coating methods for coating OPA monolayers to mica substrates: (a) misting using an atomiser, (b) forced spreading and (c) dipping. Those experiments were conducted in an attempt to extend OPA monolayer technology to objects that are not suitable for spin-coating. All of the above methods were able to make partial OPA monolayers on mica substrates. Spreading is achieved using an emulsion of OPA and solvent and a brush whose bristles are treated to give a particular interaction between OPA, solvent and bristle surface. Dipping is done in a trough where the emulsion is maintained by stirring or ultrasound and the rate of removal of the substrate from the trough is carefully controlled. Spraying is done with a nebuliser, either pneumatic, ultrasonic or electrostatic (electrospray) so that the solvent droplets delivered to the substrate also contain a surface excess of OPA solvents, thus allowing both phases to interact with the substrate under the same conditions as were realised with spin coating.

Dip coating seemed to produce good monolayers on mica substrates. Repeating the dipping/retracting the substrate into/from the solution, monolayer coverage on the substrate increased. In fact, the coverage could be as high as 90%. FIG. 11 shows the formation of SAMs and their growth through repeated dip coatings on a mica substrate. Therefore, this method is useful and practical for coating large and/or irregular objects. The other approaches left some aggregate on their partial monolayer surfaces. The spin-coating appears to be the best mode for removing excessive molecules from the existing monolayer while to allow the solution to attack the exposed substrate. Highest spin speeds tend to produce the most uniform morphology.

### EXAMPLE 7

We have used a diamond-tipped stylus to test the resistance of OPA monolayers formed using either chloroform or TCE solvent on a muscovite mica surface and a Si surface. The stylus can apply forces up to 0.5 mN on the surface. We observed that while a bare mica substrate was scratched by the stylus, OPA monolayers appeared to protect the substrate beneath from being scratched. The results are shown in FIG. 13, where the scan area is 7 μm×7 μm. FIGS. 13 (a) and 13 (c) are topographic force images for a bare mica substrate and OPA monolayers on a mica substrate, respectively. FIGS. 13 (b) and 13 (d) are friction force images for the bare mica and OPA monolayers, respectively. The two lines seen in FIGS. 13 (a) and 13 (b) indicate that the mica surface was scratched by the stylus. From the scratch width observed on the mica substrate and using the Hertzian contact model, the pressure the diamond tip imposed on the surface at the applied force was estimated to be on an order of 7 GPa.³⁴ It is clear that under such severe conditions, there were no significant changes seen on the OPA sample surface, indicating that OPA monolayers were not destroyed under the high pressure. Magnified images on the scratched area only showed a barely detectable deformation on the OPA monolayers. It is, therefore, clear that the OPA monolayer can be used to protect the mica substrate. OPA prepared on Si substrate showed similar results shown in FIGS. 13 (c) and 13 (d).

ToF-SIMS analysis of OPA monolayers on a mica substrate showed that OPA secondary ions were attached to mica substrate constituent, such as Si, SiO and SiO₂. This experimental fact suggests a possible formation of chemical bond between the OPA headgroup and the mica substrate. Therefore, the strong interaction between the OPA headgroup and the mica substrate probably provides excellent lubrication for the OPA monolayers.

### EXAMPLE 8

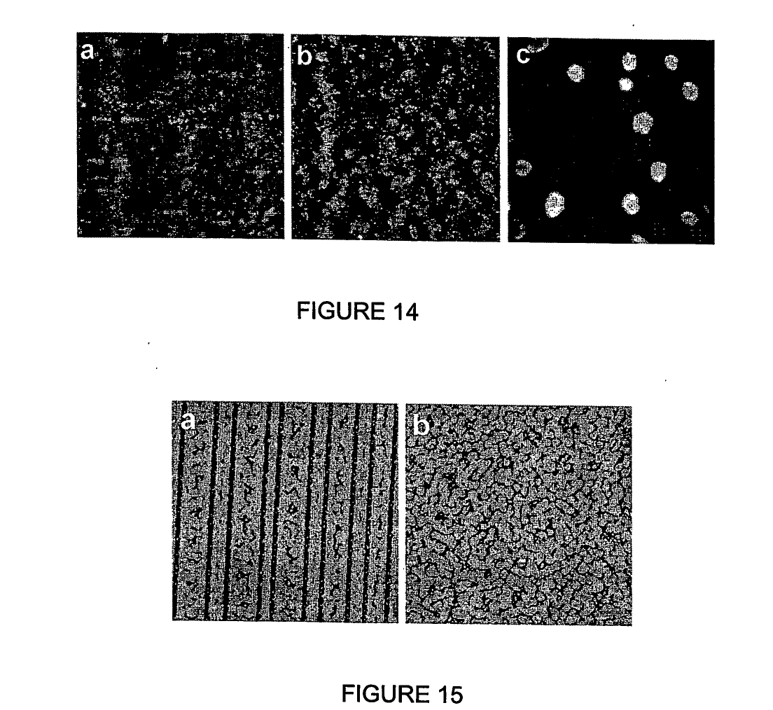

Thermal stability of OPA monolayers prepared on a Si substrate was investigated. The OPA sample was spin coated on the substrate using a 2 mM OPA solution in TCE at a relative RH of 65%. The sample was then examined using AFM followed by annealing in an oven for 30 min. As shown in FIG. 14 (a), up to 60° C., there was no significant change in morphology between the annealed samples and the original one (not shown). This suggests a good thermal stability for the OPA monolayers, because at this temperature, OPA multilayers spread coated on a Si substrate would rearrange their structures drastically.¹⁵ From 80° C., OPA molecules were found to diffuse to cover the previously unoccupied Si substrate [FIG. 14 (b)]. Even at this temperature, the Si substrate was still covered with OPA monolayers. When the sample was annealed at 90° C., the formation of multilayer islands was observed [FIG. 14 (c)].

It was noted that higher coverage OPA monolayers showed a better thermal stability than lower coverage ones. This can be explained by the fact that the molecules have to find a place to move to upon temperature (kinetic energy) increase. Lower coverage OPA monolayers provide a plenty of room for the molecules to wander, while the higher coverage OPA monolayers restrict this freedom, making them more resilient to the thermal energy increase.

### EXAMPLE 9

Scratching a surface may result in physical and/or chemical properties to change.³⁵ Such modification of a surface can have applications in surface patterning. It is demonstrated in this example that OPA monolayers spin coated on a Si substrate possess such a possibility to patterning the Si surface. The Si substrate was UV/O treated and a diamond tip was used to scratch the Si substrate under a RH of 38% and an applied force of 0.5 mN at a scan rate of 20 μm/s. The OPA molecules were spin coated on the Si substrate using a 2 mM OPA solution in TCE under a RH of 70-80%. FIG. 15 (a) shows that the scratched area on the Si substrate prior to the deposition of the OPA monolayers was uncovered by the OPA molecules. On the other hand, as shown in FIG. 15 (b), the non-scratched area prior to the OPA deposition showed a “conventional” morphology of OPA monolayers, i.e., without a specific pattern formed on the surface. We thus believe that this experimental result may open an alternative method to pattern Si substrate using a mechanical approach coupled with the monolayer deposition invention disclosed herein.

### EXAMPLE 10

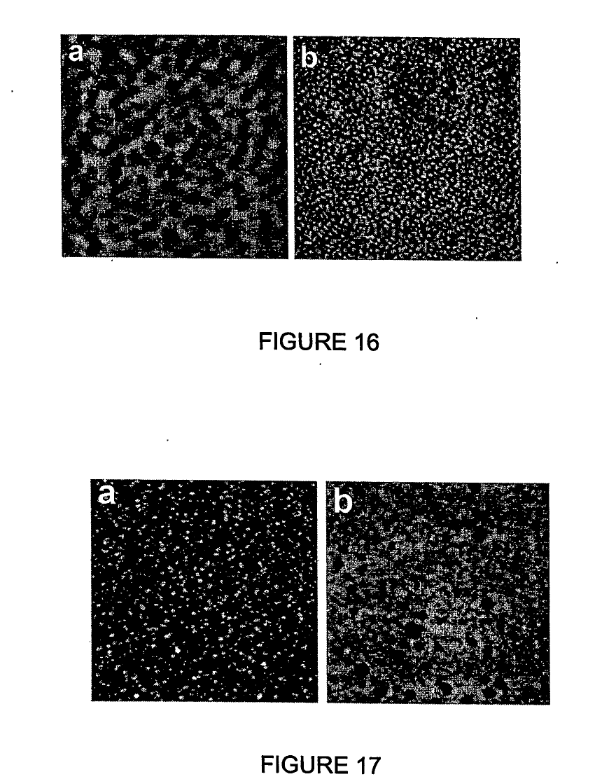

This example used spin coated molecules (dodecylphosphonic acid) having the same headgroup with OPA (18 Carbon chain) but a shorter chain (12 Carbon chain) on a mica substrate. FIGS. 16 (a) and 16 (B) show that monolayers were formed on the mica substrate under high (90%) and low (35%) RH, respectively. At high RH, the morphology of the monolayers is close to a complete monolayer. On the other hand, closely-packed particle-like features were observed when the sample was made at low RH. The difference in morphology between the OPA and the dodecylphosphonic acid is believed to be due to the difference in chain length.

### EXAMPLE 11

A 10 nm thick aluminum film was sputtered on a Si substrate. As shown in FIG. 17 (a), the aluminum film surface was characterized by particles of ˜15 nm in diameter. The surface was treated by UV/ozone for ˜40 min. OPA solution in TCE was coated on the UV/ozone treated film under a RH of ˜70%. The coating was done by allowing the solution to sit on the surface before it was spun-off. The AFM image in FIG. 17 (b) clearly shows the presence of OPA monolayers: the pits, where OPA monolayers were not deposited, contrast the OPA monolayers. It is clear from FIG. 17 (b) that the underlying Al particles are still visible as the OPA monolayers are very thin compared to the dimension of the particles.

This example demonstrates that OPA monolayers can be deposited on a particle-like surface; this compares to conventional methods that usually require single crystalline surface as the substrate on which to grow SAMs. Therefore, it is anticipated that the method disclosed herein will allow formation of amphiphilic molecular monolayer on any form of an oxidized surface.

For thicker Al film (e.g., ˜200 nm) and Al plate samples, the OPA monolayers were not revealed in AFM images, probably due to the rough surface features. However, other methods, such as contact angle measurement and ToF-SIMS analysis, indicated that OPA was deposited on the surface.

The method has been exemplified using spin coating to deposit the monolayer on the surface. As mentioned above spin coating is a preferred method and by controlling RH, concentration of self-assembling molecules in the solution and spin rate control may be exercised over the percent coverage of the surface. For growth of the monolayer on larger surfaces other methods exposing the substrate surface to the self-assembling molecules may be used. Three methods are spreading, dipping and spraying. Spreading is done with an emulsion of OPA and solvent and a brush whose bristles are treated to give a particular interaction between OPA, solvent and bristle surface. Dipping is done in a trough where the emulsion is maintained by stirring or ultrasound and the rate of removal of the substrate from the trough is carefully controlled. Spraying is done with a nebuliser either pneumatic, ultrasonic or electrostatic (electrospray) so that the solvent droplets delivered to the substrate also contain a surface excess of OPA solvents, thus allowing both phases to interact with the substrate under the same conditions as were realised with spin coating.

The fluid may be a liquid dispersion containing the molecules which can self-assemble and the hydrophobic molecules in which the substrate is immersed which is dropped onto the hydrophilic surface of the substrate which is being spun.

Alternatively, the fluid may be an aerosol containing the molecules which can self-assemble and the hydrophobic molecules.

In addition to using chloroform or trichloroethylene as the hydrophobic solvent, other hydrophobic solvents that may be used including normal alkanes such as hexane, heptane, decane, and mixtures such as light petroleum napthas and hydrophobic solvents such as carbon tetrachloride and cyclohexane.

The hydrophilic surface onto which the complete monolayer is deposited may be crystalline solids including single crystal or polycrystalline solids, amorphous solids and glassy solids. Solids from each of these categories may be semiconductors, semimetals, metals and insulators.

It is important that the surface of the substrate being coated is pre-treated prior to deposition of the monolayer to removed water molecules and any other surface impurities. A preferred pre-treatment includes exposing the surface to ultra-violet light and ozone (UVO). Such a treatment produces atomic oxygen which reacts with extended hydrocarbons and hydrates anchored to the substrate thus leaving the substrate covered only with very mobile adsorbates which provide no barrier to the reaction of the substrate with OPA/solvent to produce SAMs. The use of UVO to clean substrates such as silicon, SiO₂, metals and many other materials has been thoroughly described in the literature.

Once the monolayer has been deposited, depending on the self-assembling molecule, it may be desirable to functionalize the molecules forming the self-assembled monolayer with pre-selected moieties. There may be many reasons for doing this depending on the end application of the coated substrate. For example, the monolayer may be functionalized as a means of preparing it to receive another coating so that that monolayer acts as an intermediate layer between the surface and the additional coating. One such example would be to provide a “conversion coating” of a metal onto which another hydrophilic coating, e.g. epoxy paint is applied. Another would be a graft between a metal and a cement or adhesive such as is used to anchor dental amalgams. Such intermediate layers would provide a bond whose energy is strong, single functioned and well characterized, in contrast to the poorly understood reaction mechanisms which are found in the coatings industries today.

The method disclosed herein maybe used for the patterning of a surface in for example the microelectronics or for producing sensors. As in the examples above, a complete monolayer is produced on the substrate having a hydrophilic surface. The surface is then masked to produce a masked portion and an unmasked portion on the surface. The molecules forming the self-assembled monolayer in the unmasked portion of the monolayer coated surface are then altered in some way to produce the pre-selected pattern. The most likely method would be to use UV radiation to decompose OPA molecules bonded within an area which must be unmasked. This could be done by derivatising the hydrocarbon tails of the OPA molecules with a chromophore chosen to absorb the radiation used (a typical wavelength used recently is 190 nm). Since this is a wavelength which energy is near that of the sigma bond, it may be sufficient to produce some degree of unsaturation in the chain to bring about rapid decomposition under the UV. This could be done with a simple RF plasma treatment or possibly UVO.

The step of altering the molecules forming the self-assembled monolayer in the unmasked portion may include writing in a pre-selected pattern into the unmasked portion by using an energy beam having sufficient energy to remove, or otherwise alter, the molecules forming the self-assembled monolayer. As described above it may be useful to make the SAM more amenable to decomposition by the e beam by treatment in plasma or UVO.

The step of altering the molecules forming the self-assembled monolayer in the unmasked portion may also include functionalizing the molecules forming the self-assembled monolayer with pre-selected moieties.

The method disclosed herein provides a simple and efficient method for producing a hydrophobic coating on a hydrophilic surface. While the method has been exemplified using self-assembling OPA molecules to form the monolayer which form a highly hydrophobic layer, it will be appreciated by those skilled in the art that other self-assembling molecules may be used that are selected so that the complete monolayer is a hydrophobic layer. For example, stearic acid, lauric acid, oleic acid, ethyl laurate, lauryl alcohol etc. may be used.

The substrate may be a wing or other leading edge of an aircraft made of for example aluminum or an aluminum alloy which is prone to icing so that the hydrophobic monolayer acts an anti-icing layer.

There are other applications where a hydrophobic surface may be very desirable, such as finishing an outdoor surface for water protection and the like.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

(1) Nuzzo, R. G.; Allara, D. L. J. Am. Chem. Soc. 1983, 105, 4481.
(2) Maoz, R.; Sagiv, J. J. Colloid Interface Sci. 1984, 100, 465.
(3) Whitesides, G. M.; Mathias J. P.; Seto C. T. Science 1991, 254, 1312.
(4) Kumar, A.; Biebuyck, H. A.; Whitesides, G. M. Langmuir 1994, 10, 1498.
(5) Ulman, A. Chem. Rev. 1996, 96, 1533.
(6) Schwartz, D. K. Annu. Rev. Phys. Chem. 2001, 52, 107.
(7) Schwartz, D. K.; Steinberg, S.; Israelachvili, J.; Zasadzinski, J. A. N. Phys. Rev. Lett. 1992, 69, 3354.
(8) Woodward, J. T.; Ulman, A.; Schwartz, D. K. Langmuir 1996, 12, 3626.
(9) Vallant, T.; Brunner, H.; Mayer, U.; Hoffmann, H.; Leitner, T.; Resch, R.; Friedbacher, G. J. Phys. Chem. B 1998, 102, 7190.
(10) Neves, B. R. A.; Salmon, M. E.; Russell, P. E.; Troughton, Jr. E. B. Langmuir 2000, 16, 2409.
(11) Doudevski, I.; Schwartz, D. K. Langmuir 2000, 16, 9381.
(12) Neves, B. R. A.; Salmon, M. E.; Troughton, E. B.; Russell, P. E. Nanotechnology 2001, 12, 285.
(13) Neves, B. R. A.; Salmon, M. E.; Russell, P. E.; Troughton, E. B. Langmuir 2001, 17, 8193.
(14) Doudevski, I.; Schwartz, D. K. J. Am. Chem. Soc. 2001, 123, 6867.
(15) Nie, H.-Y.; Walzak, M. J.; McIntyre, N. S. Langmuir 2002, 18, 2955.
(16) Du, X. Z.; Hlady, V. J. Phys. Chem. B 2002, 106, 7295.
(17) Benitez, J. J.; Kopta, S.; Ogletree, D. F.; Salmeron, M. Langmuir 2002, 18, 6096.
(18) Benitez, J. J.; Kopta, S.; Diez-Perez, I.; Sanz, F.; Ogletree, D. F.; Salmeron, M. Langmuir 2003, 19, 762.
(19) Bierbaum, K.; Grunze, M.; Baski, A. A.; Chi, L. F.; Schrepp, W.; Fuchs, H. Langmuir 1995, 11, 2143.
(20) Doudevski, I.; Hayes, W. A.; Schwartz, D. K. Phys. Rev. Left. 1998, 81, 4927.
(21) Seul, M.; Sammon, M. J. Thin Solid Films 1990, 185, 287.
(22) Mennicke, U.; Salditt, T. Langmuir 2002, 18, 8172.
(23) Liu, Y.; Wolf, L. K.; Messmer, M. C. Langmuir 2001, 17, 4329.
(24) Ferraris, G.; Ivaldi, G. In Micas: Crystal Chemistry & Metamorphic Petrology; Mottana, A.; Sassi, F. P.; Thompson, J. B., Jr.; Guggenheim, S. Ed.; Mineralogical Society of America: Washington, DC, 2002; p 117.
(25) Thiel, P. A.; Madey, T. E. Surf. Sci. Rep. 1987, 7, 211.
(26) Henderson, M. A. Surf. Sci. Rep. 2002, 46, 1.
(27) Hu, J.; Xiao, X.-D.; Ogletree, D. F.; Salmeron, M. Science 1995, 268, 267.
(28) Miranda, P. B.; Xu, L.; Shen, Y. R.; Salmeron, M. Phys. Rev. Left. 1998, 81, 5876.
(29) Bluhm, H.; Inoue, T.; Salmeron, M. Surf Sci. 2000, 462, L599.
(30) Gil, A.; Colchero, J.; Luna, M.; Gomez-Herrero, J.; Baro, A. M. Langmuir 2000, 16, 5086.
(31) Kuller, A.; El-Desawy, M. A.; Stadler, V.; Geyer, W.; Eck, W. J. Vac. Sci. Techno. B 2004, 22, 1114.
(32) Cleland, G.; Horrocks, B. R.; Houlton, A. J. Chem. Soc., Faraday Trans. 1995, 91, 4001.
(33) Messerschmidt, C.; Schwartz, D. K. Langmuir 2001, 17, 462.
(34) H.-Y. Nie, D. J. Miller, J. T. Francis, M. J. Walzak, N. S. McIntyre (unpublished)
(35) Nie, H.-Y.; Walzak, M. J.; Berno, B; McIntyre, N. S. Langmuir 1999, 15, 6484.

1. A method of producing a complete monolayer on a substrate having a hydrophilic surface, comprising the steps of:
a) pre-treating a surface of a substrate having a hydrophilic surface to remove impurities therefrom; and
b) exposing the hydrophilic surface to a fluid comprising a mixture of molecules which can self-assemble on the hydrophilic surface and hydrophobic molecules for a sufficient length of time so that the molecules which can self-assemble on the hydrophilic surface form a complete self-assembled monolayer.

2. The method according to claim 1 wherein the step b) of exposing the hydrophilic surface of the substrate to the fluid includes spin coating the hydrophilic surface with the fluid in contact therewith, including adjusting spin speed.

3. The method according to claim 1 or including adjusting relative humidity (RH), concentration of the molecules of which can self-assemble.

4. The method according to claim 1, wherein the fluid is a liquid dispersion containing the molecules which can self-assemble and the hydrophobic molecules in which the substrate is immersed.

5. The method according to claim 1, wherein the fluid is an aerosol containing a liquid dispersion containing the molecules which can self-assemble and the hydrophobic molecules.

6. The method according to claim 1, wherein the substrate having a hydrophilic surface is mica, and wherein the molecules which can self-assemble are molecules of octadecylphosphonic acid, and wherein the hydrophobic solvent is chloroform or trichloroethylene.

7. The method according to claim 1, wherein the substrate having a hydrophilic surface is selected from the group consisting of mica, silicon and aluminum, and wherein the molecules which can self-assemble are molecules of octadecylphosphonic acid, and wherein the hydrophobic solvent is chloroform or trichloroethylene.

8. The method according to claim 1, wherein the substrate having a hydrophilic surface is selected from the group consisting of crystalline solids, polycrystalline solids, amorphous solids and glassy solids.

9. The method according to claim 1, wherein the substrate having a hydrophilic surface is selected from the group consisting of semiconductors, semimetals, metals and insulators.

10. The method according to claim 1, wherein the hydrophobic solvent is selected from the group consisting of normal alkanes including hexane, heptane, decane, mixtures of light petroleum napthas, carbon tetrachloride and cyclohexane.

11. The method according to claim 1 wherein the step of pre-treating the surface includes exposing the surface to ultra-violet light and/or ozone.

12. The method according to claim 1 including functionalizing the molecules forming the self-assembled monolayer with pre-selected moieties.

13. The method according to claim 1 wherein the molecules which can self-assemble on the hydrophilic surface are selected so that the complete monolayer is a hydrophobic layer.

14. The method according to claim 1 wherein the substrate is a wing of an aircraft and the hydrophobic monolayer is an anti-icing layer.

15. The method according to claim 14 wherein the substrate is made of aluminum or an aluminum alloy.

16. The method according to claim 1 wherein the step b) of exposing the hydrophilic surface of the substrate to the fluid includes spin coating the hydrophilic surface with the liquid dispersion in contact therewith, including adjusting spin speed, and wherein the molecules which can self-assemble are molecules of octadecylphosphonic acid, and wherein the hydrophobic solvent is chloroform or trichloroethylene, and wherein the substrate is selected from the group consisting of mica, aluminum, alumina and silicon

17. A method of producing a monolayer with controlled coverage on a substrate having a hydrophilic surface, comprising the steps of:
a pre-treating a surface of a substrate having a hydrophilic surface to remove impurities therefrom; and
b) exposing the hydrophilic surface to a fluid comprising a mixture of molecules which can self-assemble on the hydrophilic surface and hydrophobic molecules for a sufficient length of time so that the molecules which can self-assemble on the hydrophilic surface form a complete self-assembled monolayer; and
c) adjusting relative humidity (RH), concentration of the molecules which can self-assemble and exposure time of the substrate to the fluid to give a monolayer with a selected percentage coverage of the hydrophilic surface.

18. The method according to claim 17 wherein the step b) of exposing the hydrophilic surface of the substrate to the fluid includes spin coating the hydrophilic surface with the liquid dispersion in contact therewith, and including adjusting spin speed during spin coating.

19. The method according to claim 17 wherein the step b) of exposing the hydrophilic surface of the substrate to the fluid includes applying the fluid by misting using an atomizer.

20. The method according to claim 17 wherein the step b) of exposing the hydrophilic surface of the substrate to the fluid includes applying the fluid by forced spreading.

21. The method according to claim 17 wherein the step b) of exposing the hydrophilic surface of the substrate to the fluid includes applying the fluid dipping the substrate into the fluid.

22. The method according to claim 18 wherein the selected percentage coverage of the hydrophilic surface is in a range from about 15% to about 100% coverage is obtained by selectively adjusting spin speed in addition to relative humidity (RH), concentration of the molecules which can self-assemble and exposure time of the substrate to the fluid.

23. The method according to claim 17, wherein the substrate having a hydrophilic surface is selected from the group consisting of crystalline solids, polycrystalline solids, amorphous solids and glassy solids.

24. The method according to claim 17, wherein the substrate having a hydrophilic surface is selected from the group consisting of semiconductors, semimetals, metals and insulators.

25. The method according to claim 17, wherein the substrate having a hydrophilic surface is mica, and wherein the molecules which can self-assemble are molecules of octadecylphosphonic acid, and wherein the hydrophobic solvent is chloroform or trichloroethylene.

26. The method according to claim 17, wherein the hydrophobic solvent is selected from the group consisting of normal alkanes including hexane, heptane, decane, mixtures of light petroleum napthas, carbon tetrachloride and cyclohexane.

27. The method according to claim 17 wherein the fluid is a liquid dispersion containing the molecules which can self-assemble and the hydrophobic molecules in which the substrate is immersed.

28. The method according to claim 17 wherein the fluid is an aerosol containing a liquid dispersion containing the molecules which can self-assemble and the hydrophobic molecules.

29. The method according to claim 17 wherein the step of pre-treating the surface includes exposing the surface to ultra-violet light and/or ozone.

30. The method according to claim 17 including functionalizing the molecules forming the self-assembled monolayer with pre-selected moieties.

31. The method according to claim 17 wherein the molecules which can self-assemble on the hydrophilic surface are selected so that the complete monolayer is a hydrophobic layer.

32. The method according to claim 31 wherein the substrate is a wing of an aircraft and the hydrophobic monolayer is an anti-icing layer.

33. The method according to claim 32 wherein the substrate is made aluminum or an aluminum alloy.

34. A method of producing a complete monolayer on a substrate having a hydrophilic surface, comprising the steps of:
a) pre-treating a surface of a substrate having a hydrophilic surface to remove water molecules and/or other impurities; and
b) providing a fluid comprising a mixture of molecules which can self-assemble on the hydrophilic surface and hydrophobic molecules, the molecules which can self-assemble having a moiety which seeks a hydrophilic entity, exposing the hydrophilic surface to the fluid for a sufficient length of time so that the molecules having a moiety which seeks a hydrophilic entity are driven in a presence of the hydrophobic molecules to form a complete self-assembled monolayer.

35. The method according to claim 34 wherein the step b) of exposing the hydrophilic surface of the substrate to the fluid includes spin coating the hydrophilic surface with the liquid dispersion in contact therewith, and including adjusting spin speed during spin coating.

36. The method according to claim 35 wherein the selected percentage coverage of the hydrophilic surface is in a range from about 15% to 100% coverage is obtained by selectively adjusting spin speed in addition to relative humidity (RH), concentration of the molecules which can self-assemble and exposure time of the substrate to the fluid.

37. The method according to claim 34, wherein the substrate having a hydrophilic surface is selected from the group consisting of crystalline solids, polycrystalline solids, amorphous solids and glassy solids.

38. The method according to claim 34, wherein the substrate having a hydrophilic surface is selected from the group consisting of semiconductors, semimetals, metals and insulators.

39. The method according to claim 34, wherein the substrate having a hydrophilic surface is mica, and wherein the molecules which can self-assemble are molecules of octadecylphosphonic acid, and wherein the hydrophobic solvent is chloroform or trichloroethylene.

40. The method according to claim 34, wherein the hydrophobic solvent is selected from the group consisting of normal alkanes including hexane, heptane, decane, mixtures of light petroleum napthas, carbon tetrachloride and cyclohexane.

41. The method according to claim 34, wherein the fluid is a liquid dispersion containing the molecules which can self-assemble and the hydrophobic molecules in which the substrate is immersed.

42. The method according to claim 34, wherein the fluid is an aerosol containing a liquid dispersion containing the molecules which can self-assemble and the hydrophobic molecules.

43. The method according to claim 34 wherein the step of pre-treating the surface includes exposing the surface to one of ultra-violet light, ozone and a combination of both.

44. The method according to claim 34 including functionalizing the molecules forming the self-assembled monolayer with pre-selected moieties.

45. The method according to claim 1 wherein the step b) of exposing the hydrophilic surface to a fluid comprising a mixture of molecules which can self-assemble on the hydrophilic surface and hydrophobic molecules includes exposing the hydrophilic surface to the fluid in at least two consecutive steps.

46. The method according to any one of claim 2 wherein the step b) of exposing the hydrophilic surface to a fluid comprising a mixture of molecules which can self-assemble on the hydrophilic surface and hydrophobic molecules includes exposing the hydrophilic surface to the fluid in at least two consecutive steps, wherein the substrate is spun after each exposure.

47. The method according to claim 17 wherein the step b) of exposing the hydrophilic surface to a fluid comprising a mixture of molecules which can self-assemble on the hydrophilic surface and hydrophobic molecules includes exposing the hydrophilic surface to the fluid in at least two consecutive steps.

48. The method according to any one of claim 18 wherein the step b) of exposing the hydrophilic surface to a fluid comprising a mixture of molecules which can self-assemble on the hydrophilic surface and hydrophobic molecules includes exposing the hydrophilic surface to the fluid in at least two consecutive steps, wherein the substrate is spun after each exposure.

49. The method according to claim 34 wherein the step b) of exposing the hydrophilic surface to a fluid comprising a mixture of molecules which can self-assemble on the hydrophilic surface and hydrophobic molecules includes exposing the hydrophilic surface to the fluid in at least two consecutive steps.

50. The method according to any one of claim 35 wherein the step b) of exposing the hydrophilic surface to a fluid comprising a mixture of molecules which can self-assemble on the hydrophilic surface and hydrophobic molecules includes exposing the hydrophilic surface to the fluid in at least two consecutive steps, wherein the substrate is spun after each exposure.

51. A method of patterning a surface of a substrate, comprising the steps of:
a) producing a complete monolayer on a substrate having a hydrophilic surface, comprising the steps of
pre-treating a substrate having a hydrophilic surface to remove water molecules and/or other impurities; and
exposing the hydrophilic surface to a fluid having mixture of molecules which can self-assemble on the hydrophilic surface and hydrophobic molecules for a sufficient length of time so that the molecules which can self-assemble on the hydrophilic surface form a complete self-assembled monolayer; and
b) masking the surface with the complete self-assembled monolayer formed thereon to produce a masked portion and an unmasked portion of the surface, altering the molecules forming the self-assembled monolayer in the unmasked portion to produce the pre-selected pattern.

52. The method according to claim 51 wherein the step b) of exposing the hydrophilic surface of the substrate to the fluid includes spin coating the hydrophilic surface with the fluid in contact therewith, including adjusting spin speed.

53. The method according to claim 51 including adjusting relative humidity (RH), concentration of the molecules of which can self-assemble.

54. The method according to claim 51, wherein the step of altering the molecules forming the self-assembled monolayer in the unmasked portion includes writing in a pre-selected pattern into the unmasked portion by using an energy beam having sufficient energy to remove, or otherwise alter, the molecules forming the self-assembled monolayer in the unmasked portion to produce the pre-selected pattern.

55. The method according to claim 54 wherein the step of altering the molecules forming the self-assembled monolayer in the unmasked portion includes functionalizing the molecules forming the self-assembled monolayer in the unmasked region with pre-selected moieties.

56. The method according to claim 51, wherein the fluid is a liquid dispersion containing the molecules which can self-assemble and the hydrophobic molecules in which the substrate is immersed.

57. The method according to claim 51, wherein the substrate having a hydrophilic surface is selected from the group consisting of crystalline solids, polycrystalline solids, amorphous solids and glassy solids.

58. The method according to claim 51, wherein the substrate having a hydrophilic surface is selected from the group consisting of semiconductors, semimetals, metals and insulators.
